(19) United States
(12) Patent Application Publication
(10) Pub. No.: US 2018/0160849 A1
(43) Pub. Date: Jun. 14, 2018

(54) PORTABLE MULTI-FUNCTION COOKING SYSTEM

(71) Applicants: Michael E. Hebert, JR., Amherst, NH (US); Adam E. Wilcox, Candia, NH (US); Garrett Casey, Windham, NH (US)

(72) Inventors: Michael E. Hebert, JR., Amherst, NH (US); Adam E. Wilcox, Candia, NH (US); Garrett Casey, Windham, NH (US)

(73) Assignee: Johnson Outdoors Inc., Racine, WI (US)

(21) Appl. No.: 15/373,264

(22) Filed: Dec. 8, 2016

(51) Int. Cl. A47J 37/07

(52) U.S. Cl. CPC A47J 37/0786; A47J 37/0763

(57) ABSTRACT

A portable multi-purpose cooking system is provided. The cooking system provides a grilling surface, a griddle surface, and a stove grate contained within a cooking unit. The grilling surface and griddle surface are provided on a reversible cooking element.

### FIELD OF THE INVENTION

This invention generally relates to recreational outdoor equipment, and more particularly to portable cooking systems.

### BACKGROUND OF THE INVENTION

Portable cooking systems are used by recreational enthusiasts as a means to prepare hot food and liquids while hiking, camping, etc. Such systems are typically compact, collapsible, lightweight devices which typically operate by burning a combustible fuel such as propane.

One example of such a device is the portable stove. The portable stove typically includes one or more burners with a grate positioned above each burner which is used to support a pot or pan. The portable stove thus excels in preparing food or liquids which are cooked in such a pot or pan, e.g. soups, noodles, hot cereal, hot water, etc. Further, a griddle accessory may also be employed to allow the portable stove to function as a griddle to prepare foods typically prepared on a griddle, e.g. pancakes, bacon, etc.

Another example of a portable cooking system is the portable grill. Portable grills advantageously allow for the preparation of foods which are typically grilled, e.g. vegetables, meats, etc. These portable grills are typically larger in size than their portable stove counterparts, and typically have a higher power output to provide the searing capabilities which are expected of a grill. As a result, portable grills are generally heavier than the portable stove and are also not as compact.

Unfortunately, outdoor enthusiasts who desire to enjoy foods which are prepared by stove and by grill typically must pack both a portable stove and a portable grill. Indeed, portable stoves allow for conventional stove top cooking, and with appropriate accessories, conventional griddle cooking. These devices, however, do not provide for grilling functionality. On the other hand, portable grills do not offer stove capabilities, and as stated above tend to be heavy and relatively large.

Accordingly, there is a need in the art for a portable multi-function cooking system embodied in a single device which provides for stove top, griddle, and grilling functionality in a relatively compact, portable, and versatile package. The invention provides such a portable multi-function cooking system. These and other advantages of the invention, as well as additional inventive features, will be apparent from the description of the invention provided herein.

### BRIEF SUMMARY OF THE INVENTION

In one aspect, embodiments of the invention provides a cooking system. The cooking system includes a base with a cooking unit mounted to the base. The cooking unit includes a shell having a drip tray and a cover removably installed on the drip tray. The cooking unit also includes a burner positioned within the shell. A reversible cooking element is also situated in the shell. The cooking element has a first side and a second side in an opposed spaced relationship. The first side is configured as a grilling surface, while the second side is configured as a griddle surface. A stove grate is also positioned within the shell underneath said cooking element.

In certain embodiments, the first side which is configured as a grilling surface includes a plurality of raised ribs. The second side which provides the griddle surface includes a flat continuous surface free of any apertures. The flat continuous surface encompasses at least half of a total surface area of the first side.

In certain embodiments, the stove grate is a wire structure configured to support a container thereon in proximity to the burner such that a flame from the burner can directly contact the container.

In certain embodiments, the base includes a body and a top plate. An interior space is defined between the body and the top plate. The body can include an inlet port, an outlet port, an output, a fuel control valve assembly, and an ignition trigger mechanism.

An inlet conduit extends through the interior space and connects the inlet port to the fuel control valve assembly. A primary outlet conduit extends through the interior space and connects the output to the control valve assembly. A secondary outlet conduit extends through the interior space and connects the outlet to the control valve assembly.

The body includes at least two foldable handles which fold outwardly relative to the body. The body also includes at least three adjustable feet which are each axially adjustable relative to the body.

In another aspect, embodiments of the invention provide a cooking system having a base, a cooking unit having a shell mounted to the base, and a burner disposed within the shell. A stove grate is also positioned within the shell above the burner. A cooking element is removably positioned within the shell above the burner and separate from the stove grate.

In certain embodiments, the cooking element has a first side and a second side in an opposed spaced relationship. The first side is configured as a grilling surface, the second side is configured as a griddle surface.

The first side includes a plurality of raised ribs, and the second side includes a flat continuous surface free of apertures. The flat continuous surface encompasses at least half of a total surface area of the first side.

The stove grate is a wire structure configured to support a container thereon in proximity to the burner such that a flame from the burner can directly contact the container.

In certain embodiments, the shell includes a drip tray and a cover removable from the drip tray. A first plurality of support surfaces are arranged about a first diameter and project radially inward from an interior surface of the drip tray to support the stove grate. A second plurality of support surfaces are axially spaced from the first plurality of support surfaces and are arranged about a second diameter and project radially inward from the inner surface of the drip tray to support the cooking element. The second diameter is greater than the first diameter.

In another aspect, embodiments of the invention provide a cooking system. This cooking system includes a base which includes a fuel inlet port, a fuel outlet port, an output, an ignition trigger mechanism, and a fuel control valve assembly for controlling the flow of gas from the fuel inlet port to a burner connected to the output. A cooking unit is mounted to the base. The cooking unit includes the aforementioned burner. The cooking unit provides a stove grate, a grilling surface, and a griddle surface within a shell of the cooking unit.

The cooking unit includes a cooking element. The cooking element provides the grilling surface and the griddle surface. The grilling surface includes a plurality of raised ribs. The griddle surface includes a flat continuous surface free of apertures. The flat continuous surface encompasses at least half of a total surface area of the first side. The grilling surface and griddle surface are on opposed sides of the cooking element.

The stove grate is a wire structure configured to support a container thereon in proximity to the burner such that a flame from the burner can directly contact the container.

The base includes a body. The body has at least two foldable handles and at least three adjustable feet.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a portable multi-function cooking system according to the teachings herein;

FIG. 2 is an exploded perspective view of the system of FIG. 1;

FIG. 3 is a perspective view of one side of a cooking element of the system of FIG. 1;

FIG. 4 is a perspective view of another side of the cooking element of the system of FIG. 1, depicting the side opposite that shown in FIG. 3;

FIG. 5 is a perspective view of a base of the system of FIG. 1, with a cooking unit of the system of FIG. 1 removed for clarity; and

FIG. 6 is a perspective view of an interior space of the base, illustrating the fuel conduit routing of the system of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

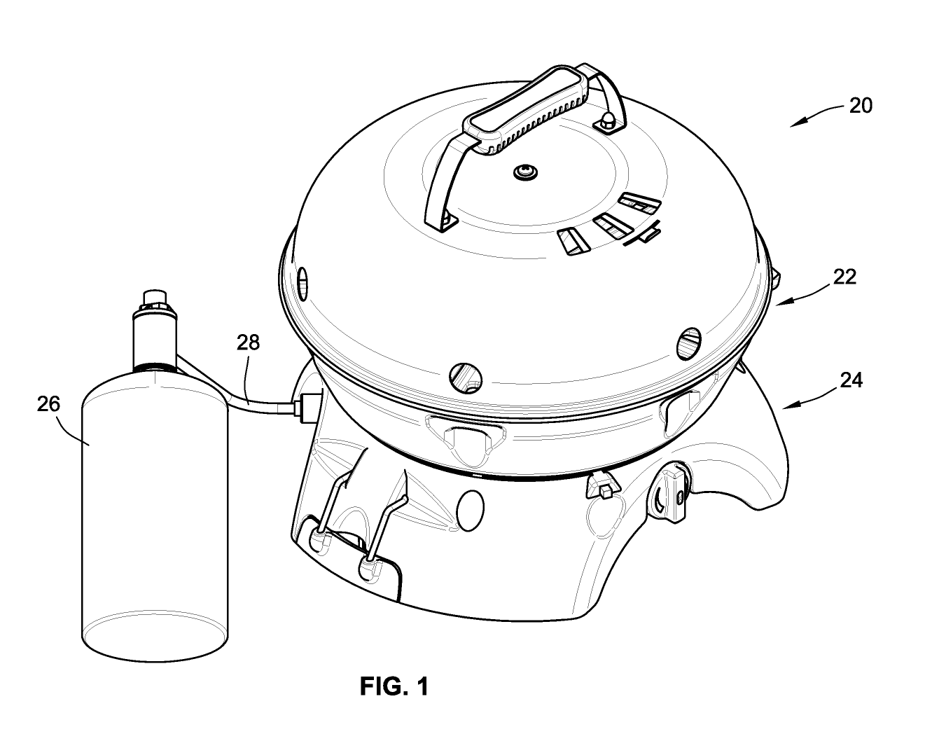

Turning now to the drawings, FIGS. 1-6 illustrate various views of an embodiment of a portable multi-function cooking system 20 (hereinafter “cooking system 20”) according to the teachings herein. System 20 advantageously provides a single device which can function as a grill, a griddle, and a stove in a small and portable package.

With particular reference now to FIG. 1, an embodiment of cooking system 20 is illustrated therein. Cooking system 20 includes a cooking unit 22 attached to a base 24. A fuel source 26 is connected to cooking system 20 via a pressure regulator assembly 28. This fuel source 26 provides a combustible gaseous fuel which is burnt within cooking unit 22 to provide a heat source. Pressure regulator assembly 28 includes an integrated pressure regulator which regulates the pressure of fuel from fuel source 26 to cooking system 20.

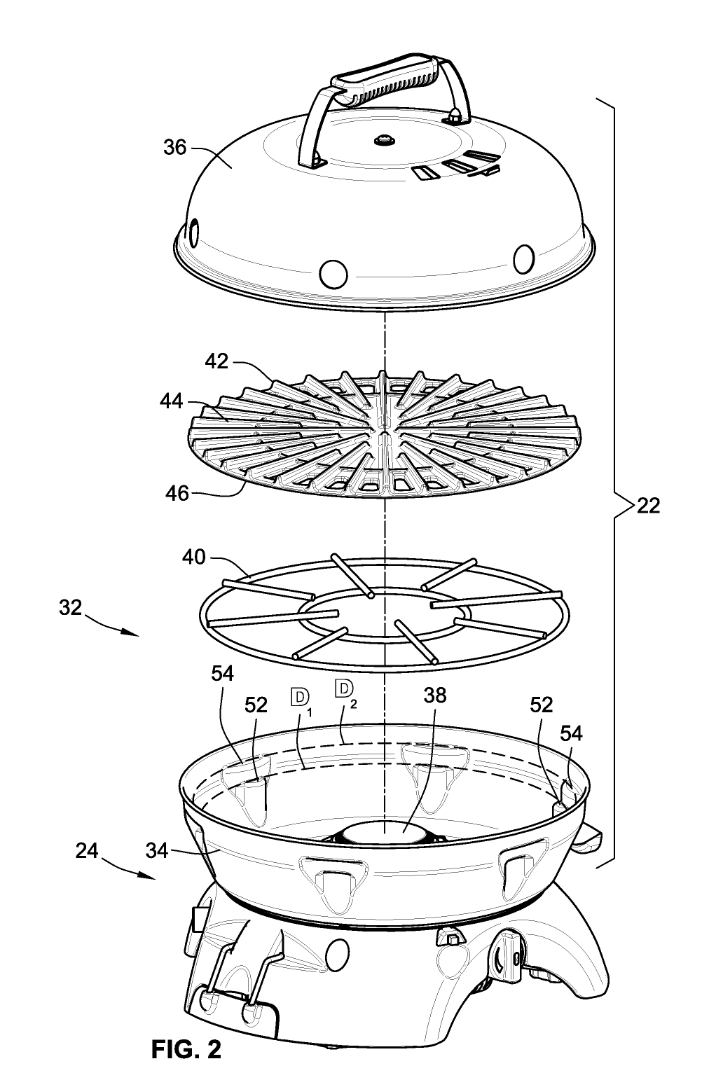

Turning now to FIG. 2, cooking system 20 is shown in a partially exploded view. Cooking unit 22 includes a shell 32 which includes a drip tray 34 and a cover 36 removable relative to the drip tray 34. A burner 38 is positioned within shell 32, and more particularly, in a bottom region of drip tray 34. As will be explained in greater detail below, this burner 38 is connected to an output which provides gaseous fuel from fuel source 26 (See FIG. 1) to burner 38. A stove grate 40 is positioned within drip tray 34 and above burner 38. A cooking element 42 is also positioned within drip tray 34 above burner 38 and above stove grate 40.

Cooking element 42 includes a first side 44 and a second side 46. As will be explained in greater detail below, these first and second sides 44, 46 have surface geometries which differ from one another. In particular, first side 44 is configured as a grilling surface, while second side 46 is configured as a griddle surface. As used herein, “configured as a grilling surface” means that the first side 44 presents a surface having a plurality of raised ribs ideal for concentrating and transferring heat at their discrete locations to cook the food and to provide parallel sear marks on the food as is typically done with a grill. As used herein, “configured as a griddle surface” means a surface which has a flat continuous surface which is free of apertures and ideal for cooking foods which begin in a liquid, e.g. pancakes, eggs, etc.

The aforementioned stove grate 40 is a wire structure configured to support a container such as a pot or pan thereof. This stove is arranged to support the aforementioned container directly above burner 38. Further, because of its generally wire construction, a flame from burner 38 can directly contact the container situated on stove grate 40 as is done with a conventional stove top. Accordingly, cooking system 20 advantageously functions as a grill, a griddle, and a stove depending upon the configuration selected by the user.

A first plurality of support surfaces 52 are arranged about reference diameter D₁ and extend radially inward from an interior surface of drip tray 34. This first plurality of surfaces 52 is arranged to support stove grate 40 thereon. A second plurality of support surfaces 54 is arranged about a second diameter D₂ and extends from the interior surface of drip tray 34. This second plurality of support surfaces 54 is axially spaced from the first plurality of support surfaces 52 as shown. Further, reference diameter D₂ is greater than reference diameter D₁ to accommodate the generally conical shape of drip tray 34. The first plurality of surfaces thus support stove grate 40 at a first axial height relative to base 24, while the second plurality of support surfaces 54 support cooking element 42 at a second axial height which is greater than the first axial height. Support surfaces 52, 54 may be equally or unequally spaced and may be in any number necessary to support stove grate 40 and cooking element 42, respectively.

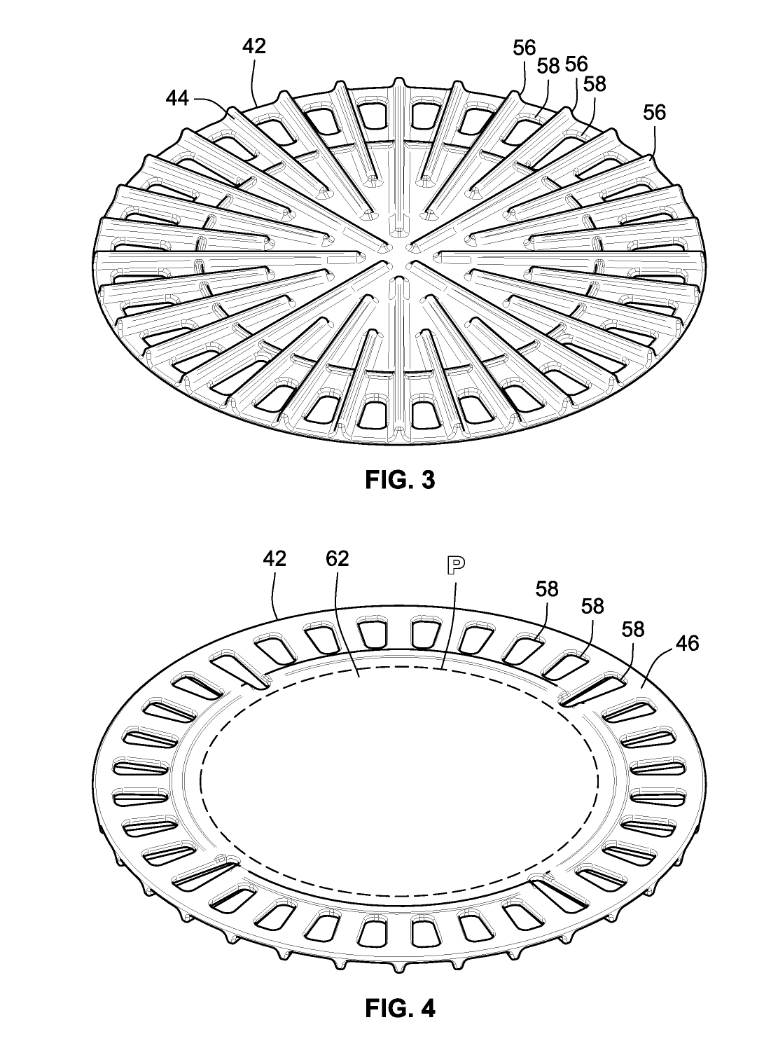

Turning now to FIG. 3, the same illustrates first side 44 of cooking element 42. As discussed above, first side 44 provides the aforementioned grilling surface by way of a plurality of spaced and raised ribs 56 as shown. As can also be seen in FIG. 3, there is a plurality of openings 58 adjacent the circumference of cooking element 42 with one opening 58 positioned between adjacent ribs 56. Openings 58 on the one hand provide ventilation holes for heated air to flow about cooking element 42 during cooking, and on the other hand provide finger holes for removing cooking element 42 from shell 34.

Turning now to FIG. 4, the same illustrates second side 46 of cooking element 42. Second side 46 provides the aforementioned griddle surface 62. As can be seen in FIG. 4, griddle surface 62 is a flat continuous surface which is free of any aperture and is denoted by reference perimeter P as shown. As can also be seen in this view, the openings 58 introduced relative to FIG. 3 extend through the entirety of cooking element 42 such that they are exposed on second side 46. Several of these openings are longer than the others and extend radially inward toward griddle surface 62. These particular openings provide a means for drainage of grease and other fluids generated during cooking.

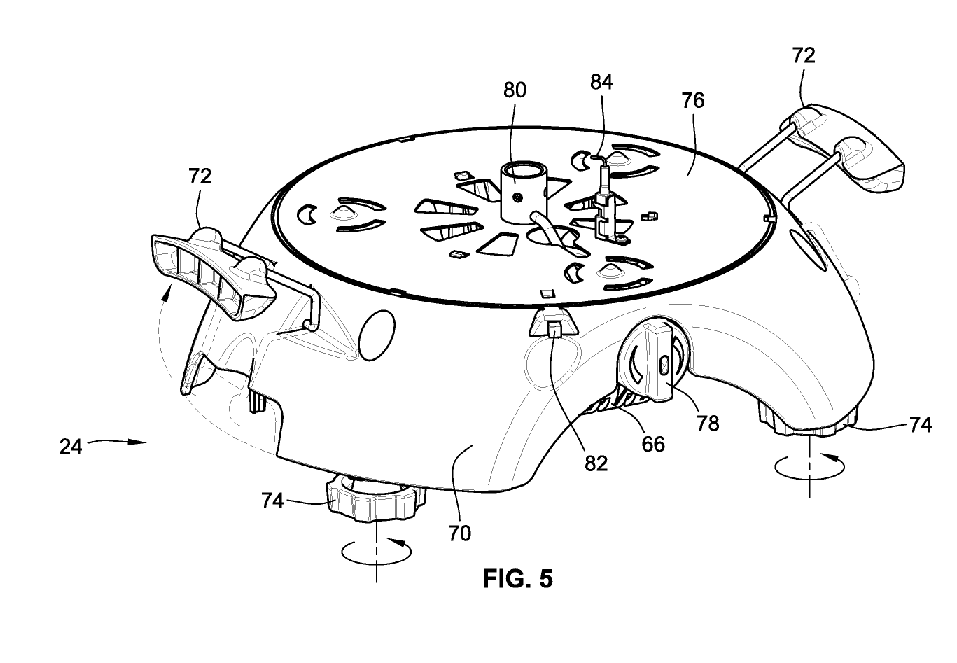

Turning now to FIG. 5, the above-introduced base 24 is shown in greater detail. Base 24 includes a body 70. At least two foldable handles 72 are connected to body 70 and are foldable as shown. Body 70 also includes at least three adjustable feet 74 which are rotatable about their center axis to adjust their axial position relative to body 70. This allows for a leveling of cooking system 20 on uneven surfaces. This adjustability is achieved by attaching feet 74 to body 70 with threaded members which may be threaded/unthreaded from body 70 to adjust their axial positioning relative thereto. Additionally, a bottom of body 70 may incorporate clip elements 66 for carrying various accessories in a snap-fit connection. In the example shown, regulator assembly 28 may be snapped into clip elements 66 for storage when not in use. Other items may also be carried by base 70, e.g. cooking utensils, cleaning utensils, etc.

A knob of a fuel control valve assembly 78 is exposed on an exterior of body 70. This fuel control valve assembly 78 is used to control the flow of fuel from fuel source 26 (See FIG. 1) to output 80 to which burner 38 attaches. Also exposed on body 70 is an ignition trigger mechanism 82. Depression of this ignition trigger mechanism 82 triggers an electrical pilot 84 positioned in proximity to output 80 and burner 38 (See FIG. 2). This is used to ignite fuel flowing from output 80 to burner 38. Output 80 and pilot 84 project through a top plate 76 which is affixed to body 70.

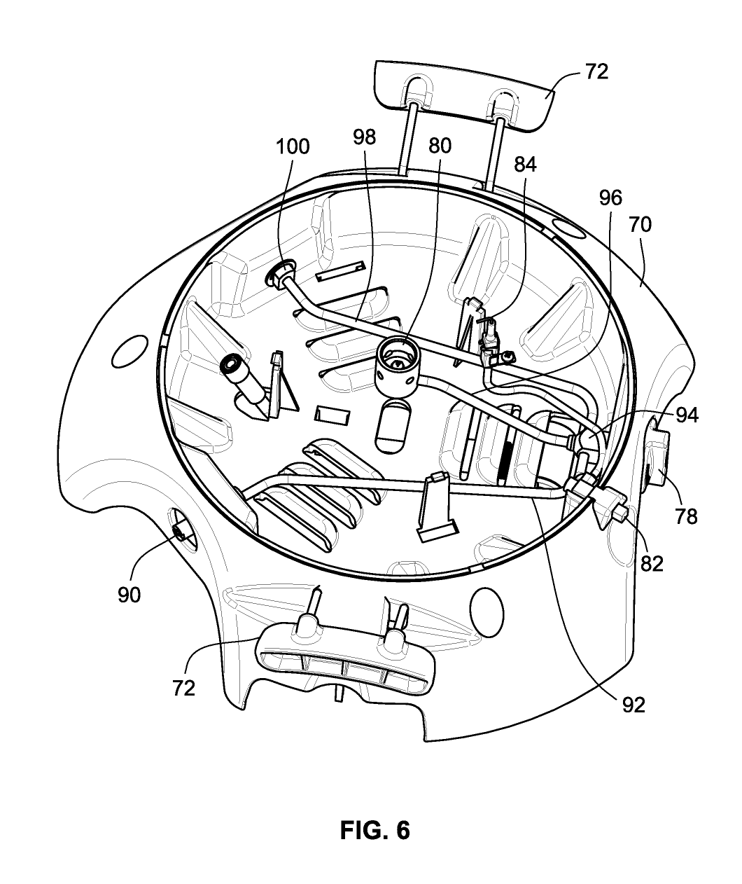

Turning now to FIG. 6, top plate 76 is removed to expose the conduit for routing fuel from fuel source 26 (See FIG. 1) throughout cooking system 20. The aforementioned conduit is generally contained within an interior space between top plate 76 and body 70. An inlet port 90 is exposed on an exterior of body 70. An inlet conduit 92 extends from inlet port 90 and connects to fuel control valve assembly 78, and more particularly, a valve body 94 thereof. A first outlet conduit extends from valve body 94 to output 80. Manipulation of the above-introduced knob of fuel control valve assembly 78 controls the flow rate of fuel from inlet port 90 to output 80. A second outlet conduit extends from valve body 94 to an outlet port 100 which is also exposed on an exterior of body 70. This outlet port 100 allows for the connection of a secondary device such as another cooking system 20, or any other device which utilizes the fuel carried by fuel source 26. Advantageously, a single fuel source 26 may be connected to inlet port 90 and provide fuel to multiple devices by way of this outlet port 100.

In operation, a user connects fuel source 26 to inlet port 90 via pressure regulator assembly 28. (See e.g. FIG. 1). The user then selects which configuration to place cooking system 20 in, i.e. a grilling, griddle, or stove configuration. To select either the grilling or griddle configuration, the user simply flips cooking element 42 so that the appropriate surface (i.e. grilling or griddle) is facing upwards. The user then rotates the knob of fuel control valve assembly 78 to provide a flow of fuel to burner 38. The user then actuates pilot button 82 to generate an ignition spark at pilot 84 to ignite the fuel at burner 38.

A similar process is employed to utilize the stove configuration. To utilize the stove configuration, fuel source 26 is connected in the same manner as above. However, in this configuration, cooking element 42 is removed from shell 34 such that stove grate 40 is exposed for use. A pot, pan, or other cooking device is situated on stove grate 40, and fuel is ignited in the same manner as described above.

As described herein, cooking system 20 advantageously provides a portable multi-function system having stovetop, grilling, and griddle functionality in a single compact package. These advantages are achieved in part by a cooking unit which carries a stove grate and a reversible cooking element which provides a grilling surface on one side and a griddle surface on the other. A user need only to select which side of cooking element to use, or alternatively, remove cooking element to utilize the stove grate.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A cooking system, comprising:
a base;
a cooking unit mounted to the base, the cooking unit including a shell having a drip tray and a cover removably installed on the drip tray, and a burner positioned within the shell;
a reversible cooking element situated in the shell, the cooking element having a first side and a second side in an opposed spaced relationship, the first side configured as a grilling surface, the second side configured as a griddle surface; and
a stove grate positioned within the shell underneath said cooking element.

2. The cooking system of claim 1, wherein the first side includes a plurality of raised ribs.

3. The cooking system of claim 1, wherein the second side includes a flat, continuous surface free of apertures.

4. The cooking system of claim 3, wherein the flat continuous surface encompasses at least half of a total surface area of the first side.

5. The cooking system of claim 1, wherein the stove grate is a wire structure configured to support a container thereon in proximity to the burner such that a flame from the burner can directly contact the container.

6. The cooking system of claim 1, wherein the base includes a body and a top plate, wherein an interior space is defined between the body and the top plate.

7. The cooking system of claim 6, wherein the body includes an inlet port, an outlet port, an output, a fuel control valve assembly, and an ignition trigger mechanism.

8. The cooking system of claim 6, wherein an inlet conduit extends through the interior space and connects the inlet port to the fuel control valve assembly, wherein a primary outlet conduit extends through the interior space and connects the output to the control valve assembly, and wherein a secondary outlet conduit extends through the interior space and connects the outlet to the control valve assembly.

9. The cooking system of claim 6, wherein the body includes at least two foldable handles which fold outwardly relative to the body, and wherein the body includes at least three adjustable feet which are each axially adjustable relative to the body.

10. A cooking system, comprising:
a base;
a cooking unit having a shell mounted to the base;
a burner disposed within the shell;
a stove grate positioned within the shell above the burner; and
a cooking element removably positioned within the shell above the burner and separate from the stove grate.

11. The cooling system of claim 10, wherein the cooking element has a first side and a second side in an opposed spaced relationship, the first side configured as a grilling surface, the second side configured as a griddle surface.

12. The cooking system of claim 11, wherein the first side includes a plurality of raised ribs, wherein the second side includes a flat continuous surface free of apertures, and wherein the flat continuous surface encompasses at least half of a total surface area of the first side.

13. The cooking system of claim 10, wherein the stove grate is a wire structure configured to support a container thereon in proximity to the burner such that a flame from the burner can directly contact the container.

14. The cooking system of claim 10, wherein the shell includes a drip tray and a cover removable from said drip tray, wherein a first plurality of support surfaces are arranged about a first diameter and project radially inward from an inner surface of the drip tray to support said stove grate, and wherein a second plurality of support surfaces axially spaced from the first plurality of support surfaces and are arranged about a second diameter and project radially inward from the inner surface of the drip tray to support said cooking element, the second diameter greater than the first diameter.

15. A cooking system, comprising:
a base, the base including a fuel inlet port, a fuel outlet port, an output, an ignition trigger mechanism, and a fuel control valve assembly for controlling a flow of gas from the fuel inlet port to a burner connected to said output; and
a cooking unit mounted to the base and including the burner, the cooking unit providing a stove grate, a grilling surface, and a griddle surface within a shell of the cooking unit.

16. The cooking system of claim 15, wherein the cooking unit includes a cooking element, the cooking element providing the grilling surface and the griddle surface.

17. The cooking system of claim 16, wherein the grilling surface includes a plurality of raised ribs, wherein the griddle surface includes a flat continuous surface free of apertures, and wherein the flat continuous surface encompasses at least half of a total surface area of the first side.

18. The cooking system of claim 17, wherein the grilling surface and griddle surface are on opposed sides of the cooking element.

19. The cooking system of claim 15, wherein the stove grate is a wire structure configured to support a container thereon in proximity to the burner such that a flame from the burner can directly contact the container.

20. The cooking system of claim 15, wherein the base includes a body having at least two foldable handles, and at least three adjustable feet.
